(19) United States
(12) Patent Application Publication
(10) Pub. No.: US 2018/0319124 A1
(43) Pub. Date: Nov. 8, 2018

(54) SCREEN FILM WITH ATTACHMENT ELEMENT

(71) Applicants: SOLUTION EXPERT 33 INTERNATIONAL CO., LTD. TAIWAN BRANCH (B.V.I.), New Taipei City (TW); SENSEAGE CO., LTD., Taipei City (TW); DONGGUAN SOLUTION 33 ELECTRONIC TECHNOLOGY CO., LTD., Dongguan City (CN); SOLUTION EXPERT 33 INTERNATIONAL CO., LTD., Tortola (VG)

(72) Inventor: Ben-Tien LIN, New Taipei City (TW)

(21) Appl. No.: 15/836,537

(22) Filed: Dec. 8, 2017

(30) Foreign Application Priority Data
May 4, 2017 (TW) 106206300
Aug. 25, 2017 (TW) 106212628

(51) Int. Cl. B32B 5/02; B32B 7/12; B32B 5/18; B32B 27/40

(52) U.S. Cl. CPC B32B 5/022; B32B 7/12; B32B 2451/00; B32B 27/40; B32B 2457/20; B32B 5/18

(57) ABSTRACT

A screen film with an attachment element is used for attaching onto an electronic device having a display screen, and the attachment element is arranged on any one edge of any one side surface of the screen film. The attachment element is configured to attach onto the display screen correspondingly in order to be installed onto the display screen of the electronic device. Accordingly, the screen film can be selectively used depending upon different electronic devices in order to achieve the effect of privacy protection effectively while having the merits of quick attachment, reusable, low cost and convenient operation.

### BACKGROUND OF THE INVENTION

### Field of the Invention

The technical field relates to a screen film, in particular, to a screen film with an attachment element capable of achieving the privacy protection effect by directly attaching market available attachment elements onto a screen film.

### Description of Related Art

Recently, with the development of network and convenience of mobile network, the usage rates of a great number of portable mobile devices/handheld devices, such as smartphones, tablet computers, notebook computers or other portable consumer electronics increases continuously, which have become products essential to the people's modern living. Researches have shown that there is an increasing probability of peeping of adjacent people at the contents of the aforementioned mobile devices of users in public areas due to spying, curiosity or accidental viewing. Therefore, to protect the privacy of users from damages or infringements, privacy sheets (or privacy filters) are developed by manufactures and are available in the market, provided to allow users to secure such films or sheets on the display monitors of the aforementioned mobile devices via the method of adhesion or external film frame structure etc.

However, for some brands, such as the mobile devices from Apple, their display monitor protective shells are made of metal such that if a current existing privacy sheet is directly adhered thereon to form a layer of privacy sheet, or a privacy sheet is embedded onto the protective shell, then glue residual is likely to left on the screen monitor during the removal of such sheets; or users cannot remove or install the privacy sheets freely depending upon the needs; therefore, the removal, installation and use of such privacy sheets are inconvenient to users. Furthermore, the current adhesion method of privacy sheets is not able to satisfy the market demands. As a result, there is a need for relevant manufacturers to seek and research for a solution capable of providing and development privacy sheets of greater convenience.

### SUMMARY OF THE INVENTION

An objective of the present invention is to provide a screen film with an attachment element capable of allowing the selective use of such screen film depending upon different electronic devices in order to achieve the effect of privacy protection effectively while having the merits of quick attachment, reusable, low cost and convenient operation.

To achieve the aforementioned objective, the present invention provides a screen film with an attachment element, used for attaching onto an electronic device having a display screen, the attachment element arranged on any one edge of any one side surface of the screen film; the attachment element configured to attach onto the display screen correspondingly in order to be installed onto the display screen of the electronic device.

Preferably, the attachment element is an attached portion or an attaching portion.

Preferably, wherein the attached portion is made of a metal material or a material selected from any one of a metal powder, plastic/rubber, adhesive agent, foam, non-woven cloth, sheathing paper/film; the attaching portion is made of a magnet or a material selected from magnetic powder, plastic/rubber, adhesive agent, foam, non-woven cloth, sheathing paper/film.

Preferably, it further comprises another attached portion or another attaching portion correspondingly arranged on another side surface of the attached portion or the attaching portion in order to enhance attachment thereof onto the display screen.

Preferably, it further comprises an adhesive material disposed at an inner side of the attached portion or the attaching portion.

Preferably, the adhesive material is any one of a double-side tape, epoxy resin AB gel, polyurethane adhesive agent or metal glue.

Preferably, it further comprises a decorative material adhered onto an outer surface of the attachment element or onto another side surface of the attachment element.

Preferably, the decorative material is made of a material of any one of a PET film, a PC film or a Mylar film.

Preferably, the screen film is a privacy filter.

Preferably, wherein the attachment element includes two folding portions, a connecting portion connected to the two folding portions and a gap formed between the two folding portions; the two folding portions attached onto the two side surfaces corresponding to the edge respectively, and the gap is configured to receive the edge therein.

Preferably, wherein the attachment element is of a horseshoe shape and encloses the edge of the screen film along a direction of the edge.

Preferably, it further comprises an adhesive material adhered onto a surface of the gap of the attachment element in order to increase an adhesive force of the attachment element.

The present invention further includes the following technical effects. The attachment element can be selectively attached and arranged onto one identical edge of any one side surface of corresponding two side surfaces of one identical edge in order to increase the magnetic attachment force appropriately such that the screen film of the present invention is able to firmly attach onto the display screen or its bracket. Furthermore, the user can remove the screen film from the display screen depending upon the needs such that it is of great convenience for quick uses and of low cost.

### BRIEF DESCRIPTION OF DRAWING

FIG. 1 is an exploded view according to the first exemplary embodiment of the present invention;

FIG. 2 is an exploded view according to the first exemplary embodiment of the present invention applied to an electronic device;

FIG. 3 is a partial cross sectional view according to the first exemplary embodiment of the present invention applied to a mobile device;

FIG. 4 is a cross sectional view of another embodiment of FIG. 1;

FIG. 5 is a cross sectional view according to the second exemplary embodiment of the present invention;

FIG. 6 is another cross sectional view according to the second exemplary embodiment of the present invention;

FIG. 7 is a cross sectional view according to the third exemplary embodiment of the present invention;

FIG. 8 is another cross sectional view according to the third exemplary embodiment of the present invention;

FIG. 9 is a perspective view according to the fourth exemplary embodiment of the present invention;

FIG. 10 is a cross sectional view according to the fourth exemplary embodiment of the present invention;

FIG. 11 is a cross sectional view according to the fifth exemplary embodiment of the present invention; and

FIG. 12 is another cross sectional view according to the fifth exemplary embodiment of the present invention.

### DETAILED DESCRIPTION OF THE INVENTION

The following provides a detailed description on the technical content of the present invention along with the accompanied drawings. However, it shall be understood that the accompanied drawings are provided for reference and illustration purposes only, which shall not be used to limit the scope of the present invention.

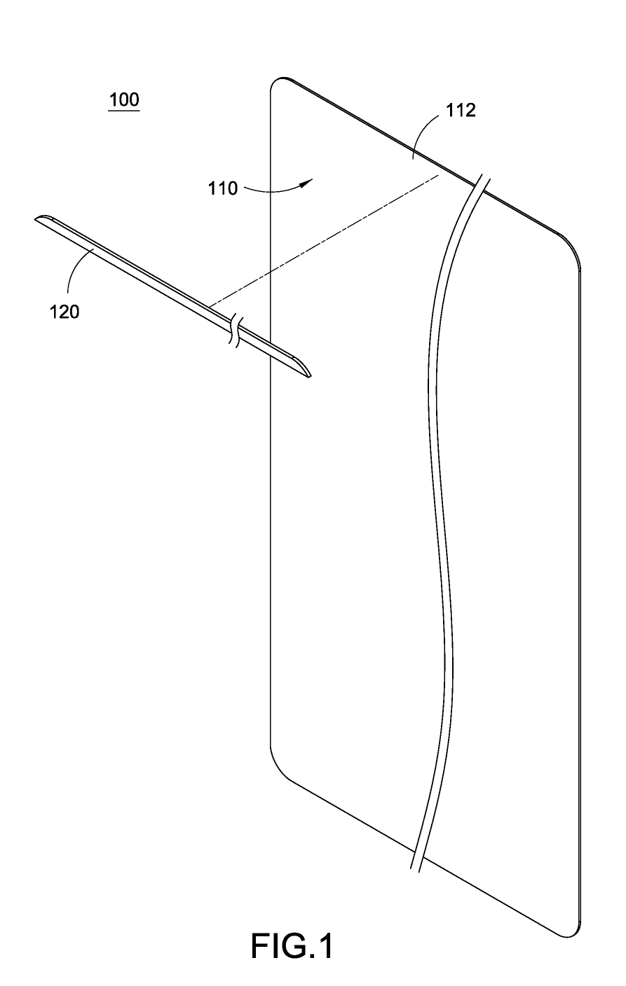

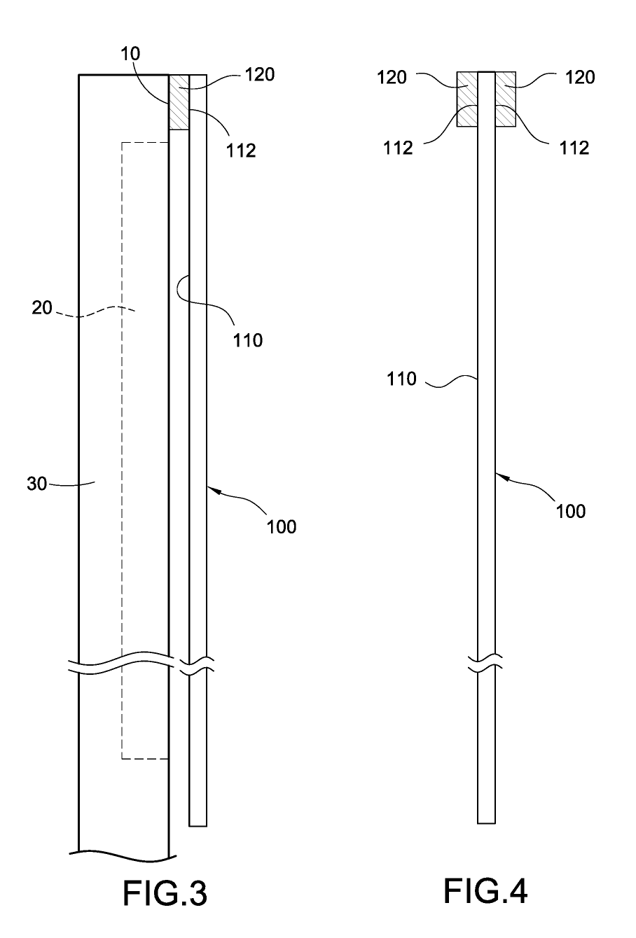

As shown in FIG. 1 to FIG. 3, the present invention provides a screen film 100 with an attachment element attached onto an electronic device 30 of a display screen 20. The electronic device 30 described here includes but not limited to the mobile electronic products of smartphones, tablet computers, notebook computers etc. However, in other different embodiments, the electronic device 30 can also be a display screen for medical use, industrial computer or other display screen 20 of electronic device 30 requiring privacy protections. In addition, the screen film 100 described here is preferably a privacy filter. However, in other different embodiments, the screen film 100 can be a composite film further integrated with the function of ultraviolet-prevention, anti-glare, anti-scratch or other functions.

For the privacy filter of the present exemplary embodiment, the structure from top to bottom is constructed by a resin layer, an adhesive layer, an optical grating layer, an adhesive layer and a resin layer sequentially. The optical grating layer is used for providing a visible range within a particular angle. To be more specific, the optical grating layer (not shown in the drawings) can be, for example, formed by a plurality of different optical grating fine boards (not shown in the drawings, which is configured by using the principle of micro louver in order to limit the light ray within a certain angle. If the horizontal left and right viewing angles exceed 30 degree, then the visibility significantly decreases with a brightness of 5% of the orthogonal viewing angle; therefore, the privacy protection effect can be achieved sufficiently. If the viewing angle deviation is greater, the brightness becomes lower such that the effect of information confidentiality can be achieved.

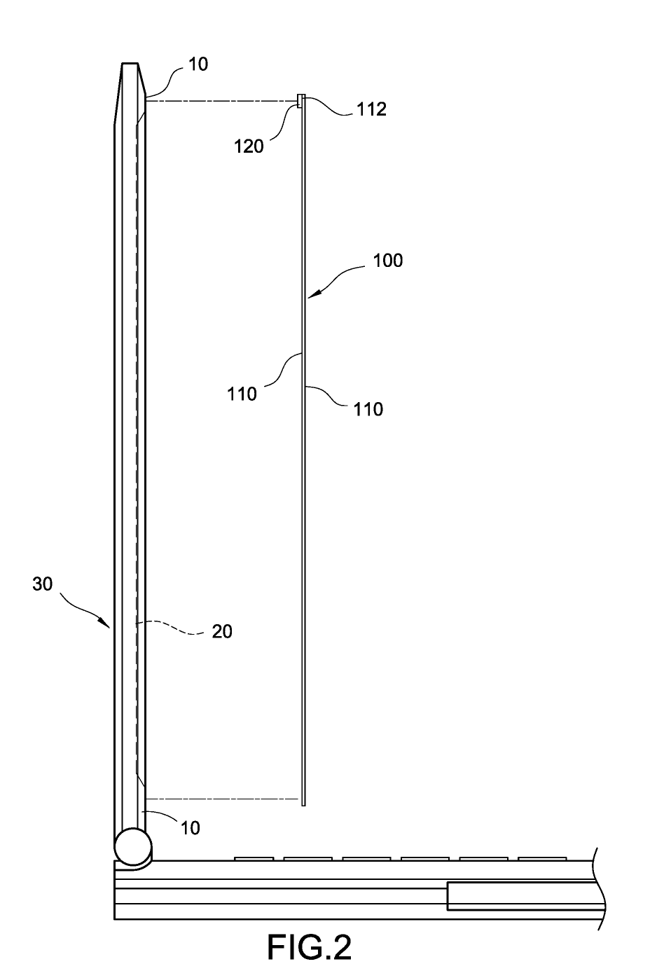

The attachment element 120 is arranged on any one edge 112 of any one side surface 110 of the screen film 100. The attachment element 120 utilizes the magnetic attraction principle to attach onto the display screen 20 correspondingly in order to cover onto the display screen 20 of the electronic device 30. In the exemplary embodiment shown in FIG. 2, the electronic device 30 is a notebook computer having a rectangular bracket 10, and the attachment element 120 of the screen film 100 can be preferably selected to be an attached portion or an attaching portion based on the material of the rectangular bracket 10 of the electronic device 30. However, in other different embodiments, the attachment element 120 of the screen film 100 can also be directly attached onto the display screen 20 of the electronic device 30, which can be changed according to the needs.

The attached portion described here can also be made of a metal material or a material selected from any one of metal powder, plastic/rubber, adhesive agent, foam, non-woven cloth, sheathing paper/film, such as metal flexible tape, metal flexible cloth, metal flexible foam, metal flexible paper/film etc. in order to be attached onto the bracket 10 of the electronic device 30 with magnetism, such as MACBOOK or other electronic products. The attaching portion can be made of a magnet or a material selected from any one of magnet powder, plastic/rubber, adhesive agent, foam, non-woven cloth, sheathing paper/film, such as magnetic flexible tape, magnetic flexible cloth, magnetic flexible foam, magnetic flexible paper/film etc. in order to be attached onto the bracket 10 of the electronic device 30 made of metal material, such as iPhone or other electronic product. Accordingly, the present exemplary embodiment can be a screen film 100 with the selective use of the aforementioned attached portion or attaching portion depending upon the needs of different electronic devices 30. The screen film 100 according to the present exemplary embodiment is of the characteristic of reusability.

When the display screen 30 or the bracket 10 of the electronic device 30 is of magnetism, the attachment element 120 can be selected to be an attached portion of a metal flexible tape, metal flexible cloth, metal flexible foam, and metal flexible paper/film. When the display screen 20 or the bracket 10 of the electronic device 30 is of a metal material, the attachment element 120 can be selected to be an attaching portion made of a magnetic flexible tape, magnetic flexible cloth, magnetic flexible foam, and magnetic flexible paper/film. Accordingly, the attachment element 120 of the present exemplary embodiment is of the merits of quick attachment, low cost and convenient operation.

Since the privacy filter can cause the issues of darkening of brightness of display screen 20 and the reduction of sharpness of the image, if it is used for a long period of time, the vision of human eyes can be damaged. Consequently, when the user uses the screen film 100 of the present exemplary embodiment in a public place, appropriate attachment element 120 can be selected for use on the bracket 10 of various types of electronic products 30 of different materials in order to be attached onto the display monitor 20 for achieving the privacy protection effect and the objective of preventing infringement of privacy. In addition, when the screen film 100 is not required or when eyes are tired, the screen film 100 can be removed quickly. Therefore, the removal and use of the screen film is extremely convenient and fast; furthermore, it does not have the problem of damaging the electronic device 30 and its bracket 10.

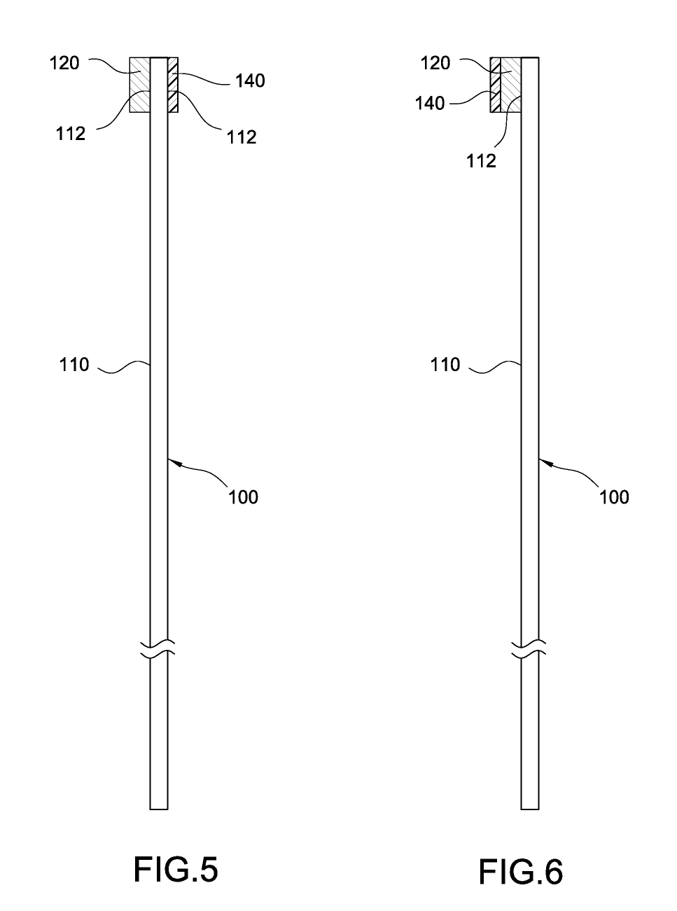

Please refer to FIG. 4. The attachment element 120 can also be attached onto one identical edge 112 of corresponding two side surfaces 110 of the screen film 100 in order to increase the magnetic attractive force on one identical edge 112. In addition, as shown in FIG. 5, it further includes a decorative material 140 attached onto another side surface 110 of the attachment element 120 in order to increase the beauty, color, brightness or presentation of business reputation etc. of the screen film 100. However, in the exemplary embodiment shown in FIG. 6, it can be understood that the decorative material 140 can also be attached onto the outer surface of the attachment element 120, and the present invention is not limited to such configurations only. The material of the decorative material 140 is preferably a PET film, PC film or Mylar film, and it can use, for example, stickers with color or LOGO, adhesive tape or other appropriate tapes for attaching onto the attachment element 120.

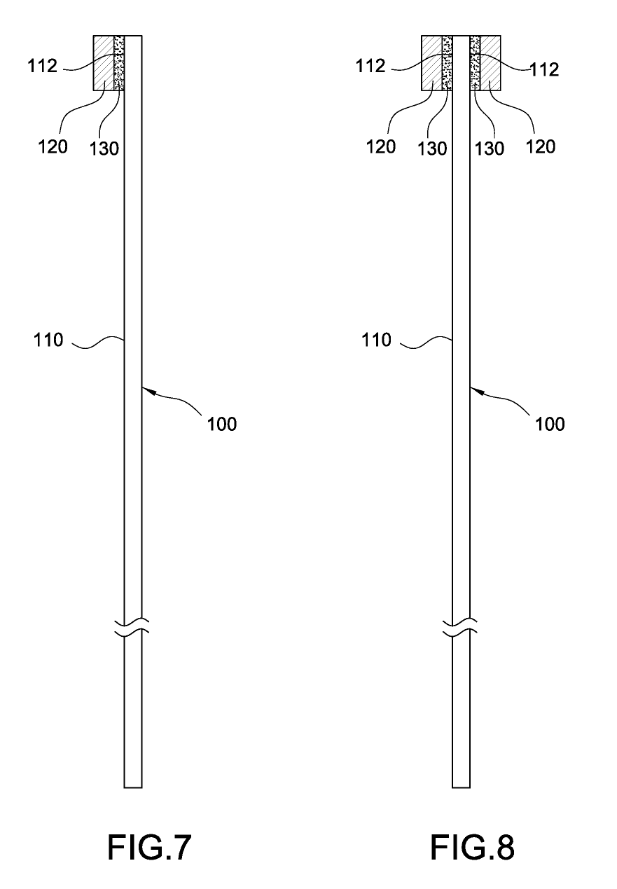

As shown in FIG. 7, it can further includes an adhesive material 130 for adhering onto the inner side of the attached portion or the attaching portion; in other words, the adhesive material 130 is adhered between the attachment element 120 and the screen film 100 in order to increase the adhesive force of the attachment element 120 attaching onto any one side surface 110 of the screen film 100. However, in the exemplary embodiment as shown in FIG. 8, the adhesive material 130 can also be adhered between the two side surface 110 of the screen film 100 and the attachment element 120. In the present exemplary embodiment, the material of the adhesive material includes but not limited to epoxy resin AB gel, double-side tape, polyurethane adhesive agent, metal glue or other appropriate adhesive agent.

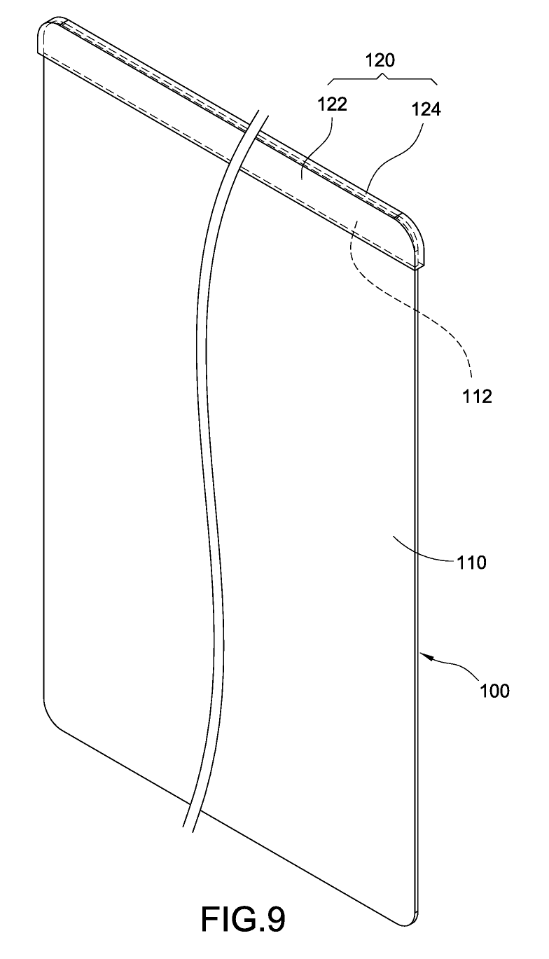

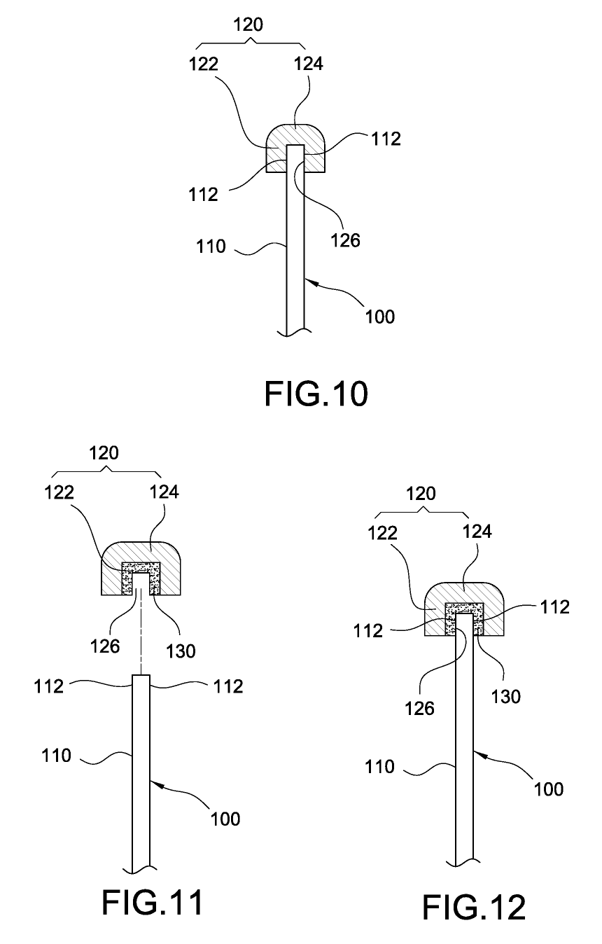

Furthermore, in a fourth exemplary embodiment of the present invention as shown in FIG. 9 and FIG. 10, the attachment element 120 can also be enclosed and arranged on the edge 112 of the screen film 100. As shown in the drawings, the attachment element 120 includes two folding portions 122, a connecting portion 124 connected to the two folding portions 122 and a gap 126 formed between the two folding portions 122. The two folding portions 122 are arranged to enclose the two side surfaces 110 of the corresponding edge 112 respectively, and the gap 126 is configured to receive the edge 112 therein. In the present exemplary embodiment, the attachment element 112 is preferably of a horseshoe shape and is arranged to enclose the edge 112 of the screen film 110 along a direction of the edge 112. However, as shown in FIG. 11 and FIG. 12, it further comprises an adhesive material 130 adhered onto the inner surface of the gap 126 of the attachment element 120 in order to increase the adhesive force of the attachment element 120 attaching onto the edge 112.

Accordingly, the attachment element 120 in each one of the aforementioned exemplary embodiment can be arranged onto any one edge 112 of the screen film 100 via the method of direct attachment, adhesion or enclosure etc., which is facilitated for manufacturing and of low cost. In addition, based on different products and different habits of consumers, the attachment element 120 of the aforementioned exemplary embodiments can be selectively attached onto the edge 112 of one side or more of any one side surface 110 or corresponding two side surfaces 110 of one identical edge 112 in order to increase the magnetic attractive force; consequently, the screen film 100 of all of the aforementioned exemplary embodiments can be firmly attached onto the display screen 20 or the bracket 10 thereof. Moreover, the user can remove the screen film 100 from the display screen or the bracket thereof at any time depending upon the needs such that its use is convenient, fast, reusable and of low cost.

The above describes the preferable and feasible exemplary embodiments of the present invention for illustrative purposes only, which shall not be treated as limitations of the scope of the present invention. Any equivalent changes and modifications made in accordance with the scope of the claims of the present invention shall be considered to be within the scope of the claim of the present invention.

What is claimed is:

1. A screen film with an attachment element, used for attaching onto an electronic device having a display screen, the attachment element arranged on any one edge of any one side surface of the screen film; the attachment element configured to attach onto the display screen correspondingly in order to be installed onto the display screen of the electronic device.

2. The screen film with an attachment element according to claim 1, wherein the attachment element is an attached portion or an attaching portion.

3. The screen film with an attachment element according to claim 2, wherein the attached portion is made of a metal material or a material selected from any one of a metal powder, plastic/rubber, adhesive agent, foam, non-woven cloth, sheathing paper/film; the attaching portion is made of a magnet or a material selected from magnetic powder, plastic/rubber, adhesive agent, foam, non-woven cloth, sheathing paper/film.

4. The screen film with an attachment element according to claim 2, further comprising another attached portion or another attaching portion correspondingly arranged on another side surface of the attached portion or the attaching portion in order to enhance attachment thereof onto the display screen.

5. The screen film with an attachment element according to claim 4, further comprising an adhesive material disposed at an inner side of the attached portion or the attaching portion.

6. The screen film with an attachment element according to claim 2, further comprising another attached portion or another attaching portion correspondingly arranged on another side surface of the attached portion or the attaching portion in order to enhance attachment onto the display screen.

7. The screen film with an attachment element according to claim 6, further comprising an adhesive material adhering onto an inner side of the attached portion or the attaching portion.

8. The screen film with an attachment element according to claim 3, wherein the adhesive material is any one of a double-side tape, epoxy resin AB gel, polyurethane adhesive agent or metal glue.

9. The screen film with an attachment element according to claim 1, further comprising a decorative material adhered onto an outer surface of the attachment element or onto another side surface of the attachment element.

10. The screen film with an attachment element according to claim 9, wherein the decorative material is made of a material of any one of a PET film, a PC film or a Mylar film.

11. The screen film with an attachment element according to claim 1, wherein the screen film is a privacy filter.

12. The screen film with an attachment element according to claim 1, wherein the attachment element includes two folding portion, a connecting portion connected to the two folding portions and a gap formed between the two folding portions; the two folding portions attached onto the two side surfaces corresponding to the edge respectively, and the gap is configured to receive the edge therein.

13. The screen film with an attachment element according to claim 12, wherein the attachment element is of a horseshoe shape and encloses the edge of the screen film along a direction of the edge.

14. The screen film with an attachment element according to claim 12, further comprising an adhesive material adhered onto a surface of the gap of the attachment element in order to increase an adhesive force of the attachment element.
